(19) United States
(12) Patent Application Publication
(10) Pub. No.: US 2026/0219946 A1
(43) Pub. Date: Jul. 30, 2026

(54) TAG GENERATION FOR COMPUTING ENVIRONMENT RESOURCES

(71) Applicant: Hewlett Packard Enterprise Development LP, Spring, TX (US)

(72) Inventors: Gavin Brebner, St. Martin D'Uriage (FR); Guoping Jia, Gieres (FR)

(21) Appl. No.: 19/071,840

(22) Filed: Mar. 6, 2025

(30) Foreign Application Priority Data
Jan. 30, 2025 (EP) 25305133.8

(51) Int. Cl. G06F 9/50

(52) U.S. Cl. CPC G06F 9/5033

(57) ABSTRACT

In some examples, a system receives connectivity information indicating how a plurality of resources of a computing environment are connected. Based on the connectivity information, the system infers a first collection of tags to associate with the plurality of resources. The system receives one or more further collections of tags provided from one or more sources, and the system generates, based on the first collection of tags and the one or more further collections of tags, an output collection of tags. The system performs a management action in the computing environment using the output collection of tags.

### BACKGROUND

A computing environment can include various resources that can be used to perform tasks on behalf of requesters. A requester can include a user, a program, or a machine. An example of a computing environment is a cloud computing environment, which provides resources in one or more clouds for use by tenants of the cloud computing environment. Examples of resources include virtual compute entities such as virtual machines (VMs) or containers. Other examples of resources include databases, servers, programs, network devices, and so forth.

### BRIEF DESCRIPTION OF THE DRAWINGS

Some implementations of the present disclosure are described with respect to the following figures.

FIG. 1 is a block diagram of an arrangement including a computing environment management system, a tag management system, and a tag converter, according to some examples.

FIG. 2 is a block diagram of an arrangement including a computing environment, a tag inference engine, and a tag rule engine, according to some examples.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

It may be desirable to associate tags with the resources of a computing environment. A “tag” can refer to any information that indicates a property of a resource. The tags associated with the resources can be used to perform management actions in the computing environment. The tags may be manually generated by one or more users. In a large computing environment with many resources and a complex interconnection of the resources, it may be labor-intensive, consume a lot of time, and error prone. Moreover, manually added tags may be duplicative of or inconsistent with tags that may already exist.

In accordance with some implementations of the present disclosure, a tag management system includes a tag inference engine and a tag rule engine. The tag inference engine infers tags based on connectivity information of resources in a computing environment. The connectivity information indicates how a plurality of resources of a computing environment are connected. The tags inferred by the inference engine form an inferred collection of tags. One or more other sources may provide other collection(s) of tags. The tag rule engine can apply a rule to combine the multiple collections of tags to produce a rule-based collection of tags. Further, the different collections of tags (including the inferred collection of tags, the rule-based collection of tags, and other collection(s) of tags) can be converted into an output collection of tags that can be used by a computing environment management system in performing management actions in the computing environment.

Examples of management actions can include any or some combination of the following: managing resources, including discovering resources, provisioning resources, orchestrating resources, or removing resources; performing policy-based control of resources; enforcing security policies in the computing environment; deploying and management workloads on resources; monitoring activities of resources or services that use resources; deploying and managing services that use resources; performing maintenance on or repairs of resources, or other actions. A management action performed on a set of resources can be applied to the set of resources directly, or alternatively, can be applied to entities that make use of the set of resources. The entities that make use of the set of resources can include any or some combination of the following: a service, a machine, a program, a user or group of users, an organization, or any other type of entity.

A management action can be performed based on one or more tags of the output collection of tags. For example, the computing environment management system (or another requester) can issue request that a requested management action is to be applied to resources associated with certain tag(s) included in the output collection of tags. For example, a service in the computing environment may employ a given set of resources. The tag rule engine may have generated a rule-based tag to assign the service based on combining the tags assigned to the resources of the given set of resources. This rule-based tag assigned to the service can be referred to as a “service tag.” Then, using the service tag, the computing environment management system (or another requester) can issue request that a requested management action is to be applied to the service, e.g., terminate the service, start the service, modify the service, etc. Performing the requested management action with respect to the service can affect the given set of resources used by the service. For example, if the service is terminated, then the given set of resources may be freed up for other use or terminated (e.g., virtual machines (VMs) or containers used by the service may be terminated).

In further examples, another action that can be performed in a computing environment can include determining a cost of using resources in the computing environment. For example, a tenant of a cloud computing environment operated by a cloud provider (the cloud provider is different from the tenant) may wish to track a cost of a service requested by the tenant that uses resources of the cloud computing environment. The tenant can issue a cost request including the tag assigned to the service to a billing system of the cloud computing environment, and the billing system can return an estimated cost for the service.

Use of the tag management system including the tag inference engine and the tag rule engine enables automated generation of tags to assign resources as well as entities that make use of the resources, so that various actions can be performed with respect to resources or entities that make use of the resources. The automated generation of tags can be efficiently and accurately performed, which improves the ability to manage the resources. The automatically generated tags using the tag inference engine and the tag rule engine can produce a richer set of tags than available in manually created tags. Also, by automatically generating tags, less manual labor can be expended in creating tags.

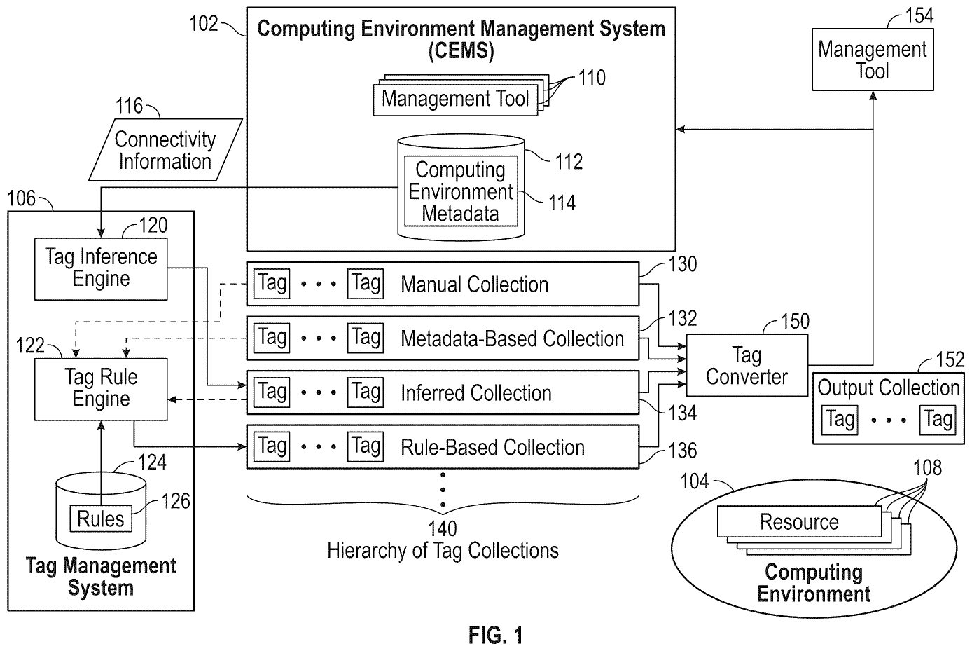

FIG. 1 is a block diagram of an example arrangement that includes a computing environment management system (CEMS) 102 for a computing environment 104, and a tag management system 106 according to some examples of the present disclosure. Each of the CEMS 102 and the tag management system 106 can be implemented using one or more computers. In other examples, the tag management system 106 and the CEMS 102 can be integrated into the same system of one or more computers.

The computing environment 104 includes various resources 108. Examples of the resources include virtual compute entities, such as virtual machines (VMs) or containers; servers; databases; programs (e.g., application programs, operating systems, system firmware, etc.); network devices (e.g., switches, routers, gateways, etc.); or other types of resources. The computing environment 104 may be a cloud computing environment including one or more clouds (e.g., a private cloud, a public cloud, a hybrid cloud, or another type of cloud), a data center, or any other type of computing environment.

The CEMS 102 includes management tools 110 that can perform various management actions, including any of the management actions discussed further above. In some examples where the computing environment 104 is a cloud computing environment, the CEMS 102 can include a cloud management platform (CMP) that manages cloud resources.

The CEMS 102 further includes a repository 112 storing computing environment metadata 114 associated with the computing environment 104. The repository 112 can be implemented using one or more storage devices.

The computing environment metadata 114 includes information describing various aspects of the computing environment 104, including the computing environment's resources 108. For example, the computing environment metadata 114 includes connectivity information 116 that indicates how the resources 108 are connected to one another. For example, the connected connectivity information 116 can specify that a first group of resources is connected to a first network (e.g., a first local area network or LAN), a second group of resources is connected to a second network, a database is connected to a third network (e.g., a storage area network or SAN), a server including an application program is connected to a fourth network, and so forth.

As another example, the connected connectivity information 116 can specify that one group of resources is within a first secure network domain (e.g., connected behind a first firewall device), and another group of resources is within a second secure network domain (e.g., connected behind a second firewall device).

The tag management system 106 includes a tag inference engine 120 and a tag rule engine 122. The tag management system 106 includes a repository 124 for that rules 126 to be applied by the tag rule engine 122.

In some examples, the tag inference engine 120 and the tag rule engine 122 can be implemented with machine-readable instructions executable by a processing resource of the tag management system 106. In further examples, the tag inference engine 120 and the tag rule engine 122 can be implemented in VMs or containers, such as VMs or containers executed in the CEMS 102 or outside the CEMS 102.

The tag inference engine 120 receives the connectivity information 116 from the CEMS 102. In some examples, the tag inference engine 120 can obtain the connectivity information 210 (and any other computing environment metadata 114) through an application programming interface (API) of the CEMS 102. The tag inference engine 120 can access the API, and invoke routines in the API to obtain the connectivity information 116 and any other computing environment metadata 114. The API of the CEMS 102 is an interface to data in the repository 112, for example.

In other examples, the tag inference engine 120 can access the repository 112 directly without using the API of the CEMS 102. Alternatively, instead of using connectivity information from the CEMS 102, the tag management system 106 can launch agents to scan the computing environment 104 to discover what resources are present in the computing environment 104 and how the resources are connected.

Based on the connectivity information 116, the tag inference engine 120 generates an inferred collection of tags 134. The tag inference engine 120 can assign tags to resources 108 based on how the resources 108 are connected to one another. For example, resources that are connected to a first network can be assigned a network 1 tag, to indicate that the first group of resources are connected to network 1. A second group of resources connected to network 2 can be signed a network 2 tag, to indicate that the second group of resources 108 is connected to network 2. It is noted that there may be some overlap among the first and second groups of resources 108. For example, a given resource may be connected to both networks 1 and 2, and thus, the given resource can be assigned both the network 1 tag and the network 2 tag.

As another example, the connectivity information 116 can indicate that different groups of resources are part of different secure network domains, based on which firewall devices that resources are connected behind. In this latter example, the tag inference engine 120 can assign a domain 1 tag to one group of resources that is part of one secure network domain, and assign a domain 2 tag to another group of resources that is part of another secure network domain.

In some examples, the connectivity information 116 can be in the form of a network graph that represents resources as vertices and connections between resources as edges. In other examples, the connectivity information 116 can be in the form of text information.

In additional examples, the connectivity information 116 can also include communication policies used by network devices (e.g., switches, routers, gateways, etc.) to determine whether resources are allowed to communicate with one another, an if so, how data packets are to be forwarded along network paths based on information in the data packets. For example, a communication policy can include an access control policy that specifies which resources are permitted (or not permitted) to access certain other resources. As another example, a communication policy can include a forwarding policy to how a data packet is to forwarded from a source resource to a destination resource. The tag inference engine 120 can use the communication policies to determine that a particular group of resources are able to communicate with one another, and thus assign a communication group tag to the particular group of resources. The communication policies can indicate that another group of resources are able to communicate with one another, and thus is assigned another communication group tag.

In further examples, the tag inference engine 120 can assign tags based on other types of computing environment metadata 114. For example, the computing environment metadata 114 can indicate the types of programs run in respective resources, such as versions of operating systems (OSes), versions of the system firmware (e.g., boot code), and so forth. Also, different resources may include different types of hardware components, such as types of central processing units (CPUs), types of graphics processing unit (GPUs), types of input/output (I/O) devices, and so forth. A resource including a specific type of component (e.g., an OS version, a system firmware version, a CPU type, a GPU type, an I/O device type, etc.) can be assigned a respective component type tag indicating that the resource includes the specific type of component.

The inferred collection of tags 134 is part of a hierarchy of tag collections 140. A “hierarchy” of tag collections can refer to any separate arrangement of tag collections where different tag collections are defined by different data structures, such as different files, objects, etc.

The hierarchy of tag collections 140 further includes other tag collections, including a manual collection of tags 130 and a metadata-based collection of tags 132. The manual collection of tags 130 can be generated based on user input through a human interface. For example, a user interface can be presented to user devices associated with one or more users to allow the user(s) to supply tags to associate with respective resources 108. A user may be a computing environment administrator, for example. As another example, a user can generate a file that contains tags associated with resources, to define the manual collection of tags 130.

The metadata-based collection of tags 132 includes tags that are based on metadata associated with the resources 108. In some examples, the metadata-based collection of tags 132 may be generated by the CEMS 102, or by another tool that is able to process the metadata associated with resources.

The metadata associated with the resources 108 may be part of the computing environment metadata 114. For example, VMs or containers may be associated with respective metadata, which can be used to generate the metadata-based collection of tags 132. For example, the metadata associated with the VMs or containers can indicate names of the VMs or containers, sizes of the VMs or containers, dates of creation or modification of the VMs or containers, or other properties of the VMs or containers. Other types of resources, such as servers, databases, programs, or network devices, can also have associated metadata.

The different collections of tags are supplied as inputs to the tag rule engine 122. Based on one or more rules 126, the tag rule engine 122 can combine multiple tags from the different collections of tags to form a rule-based collection of tags 136. A rule 126 can specify what combination of resources are used by an entity, such as a service, a machine, a program, a user or group of users, an organization, etc.

For example, a service executable in the computing environment 104 can use resources associated with certain tags. A service can refer to any collection of activities that can be performed at the request of a requester, which can be a human, a program, or a machine.

A service tag, TAG_SERVICE, assigned to the service can be produced according to the following:

$$TAG\_SERVICE = TAG 1 ‖ TAG 2 ‖ TAG 3.$$

A rule 126 (FIG. 1) used by the tag rule engine 122 can specify that a service uses resources connected to network 1 (e.g., TAG1 may be a network 1 tag from the inferred collection of tags 134), resources having a certain property (e.g., TAG2 may be a metadata-based tag from the metadata-based collection of tags 132), and resources assigned a manually created tag (e.g., TAG3 may be a manual tag from the manual collection of tags 130).

The operator ∥ is a Boolean OR operator. Thus, the service assigned the service tag, TAG_SERVICE, uses any of the resources assigned TAG1, TAG2, or TAG3. A management action can be initiated in the computing environment 104 with respect to the service using the service tag, TAG_SERVICE. The service tag, TAG_SERVICE, can be stored at the CEMS (such as in the repository 112 or another repository) in association with the tags TAG1, TAG2, and TAG3, which are associated with respective resources. When the management action is performed with respect to the service (using its service tag, TAG_SERVICE), a corresponding management action can be applied to the resources associated with the tags TAG1, TAG2, and TAG3. For example, terminating the service may cause the resources associated with the group tags TAG1, TAG2, and TAG3 to be terminated or freed up for use by other services.

More generally, the tag rule engine 122 applies a rule 126 to combine tags associated with respective resources. The combination can refer to any Boolean operation applied on the tags. An entity tag, TAG_ENTITY, can be assigned by the tag rule engine 122 to an entity that uses resources assigned a specific combination of tags:

$$TAG\_ENTITY = ( TAG 4 ‖ TAG 5 ) \&\& ! TAG 6.$$

The foregoing Boolean operation indicates that the resources used by the entity assigned the entity tag, TAG_ENTITY, include resources assigned either TAG4 or TAG5 but not TAG6.

The different collections of tags of the hierarchy of tag collections 140 can be provided as inputs to a tag converter 150. Although the tag converter 150 is shown as outside the tag management system 106, in other examples, the tag converter 150 may be part of the tag management system 106. The tag converter 150 produces an output collection of tags 152 that converts the different collections of tags 130, 132, 134, and 136 into a specific format. In some cases, the different collections of tags 130, 132, 134, and 136 may be defined in different files. The tag converter 150 can combine the different files into one file (e.g., a flattened file) that includes the output collection of tags 152. There may be duplicate tag names assigned to tags in the different files for the tags in the collections of tags 130, 132, 134, and 136. The tag converter 150 can attach prefix or postfix strings to the tag names to avoid tag name clashes.

The output collection of tags 152 can be provided to a management tool to perform a management action in the computing environment 104. The management tool can include any of the management tools 110 of the CEMS 102, or a management tool 154 that is outside the CEMS 102. In some examples, the output collection of tags 152 may be stored by the CEMS 102 in the repository 112 or another data repository.

The tag inference engine 120 and the tag rule engine 122 can be triggered to perform their respective tag generation tasks in response to certain events. The events can include any or some combination of the following: a user request that asks the tag inference engine 120 and/or the tag rule engine 122 to generate tags; a scheduled trigger that causes the tag inference engine 120 and/or the tag rule engine 122 to generate tags on a scheduled basis; an update of a resource (including adding a resource, modifying a resource, or removing a resource); or any other event.

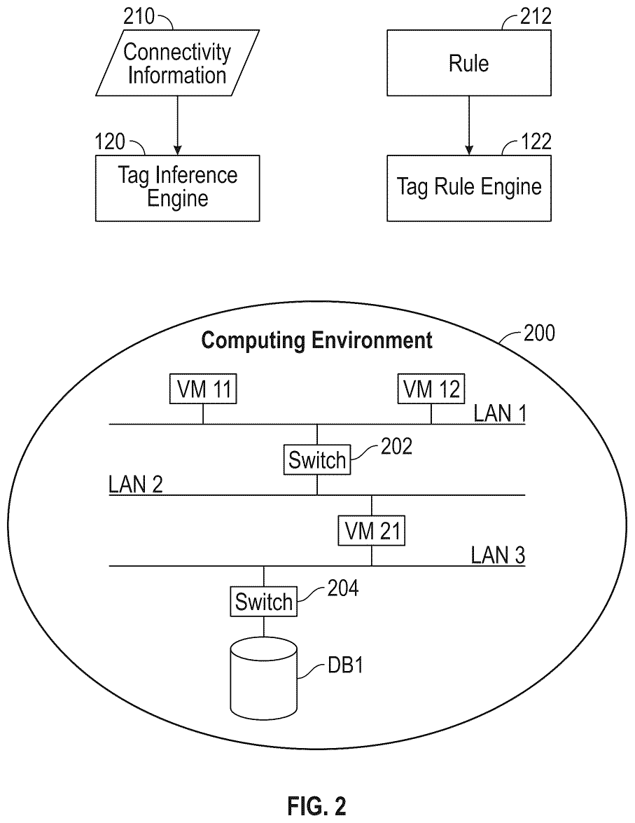

FIG. 2 is a block diagram of a computing environment 200 that includes various resources. The resources include VMs 11 and 12 connected to LAN 1, and a VM 21 connected to both LAN 2 and LAN 3. A switch 202 interconnects LAN 1 to LAN 2. A switch 204 connects a database DB1 to LAN 3.

In the example, VMs 11 and 12 can provide the frontend of a data service. A “frontend” can include a computing component that is accessible to a requester (e.g., a user) of the data service. The data service is a service that supports access and manipulation of data, such as the data stored in a data repository such as database DB1. As examples, the VMs 11 and 12 can present user interfaces that can be displayed on a user device associated with the user. The VMs 11 and 12 can further handle requests for the data service requested from the user.

The VM 21 can provide a backend of the data service, where a “backend” can include a computing component that processes requests received from the frontend (including the VMs 11 and 12 in the example). The requests received by the VMs 11 and 12 from requesters can be forwarded by the VMs 11 and 12 over LAN 1, through the switch 202, and over LAN 2 to the VM 21. In response to the requests, the VM 21 can access database DB1 over LAN 3 and through the switch 204. Database DB1 is also part of the data service. The data read from database DB1, or derived data computed from the data read from database DB1, can be returned to VM 21, which forwards the returned data to VMs 11 and 12 to send back to the requesters.

The tag inference engine 120 receives connectivity information 210, such as from the CEMS 102 of FIG. 1, describing how the resources of the computing environment 200 are connected to one another. Based on the connectivity information 210, the tag inference engine 120 can infer a LAN_1_TAG assigned to a group of VMs including VMs 11 and 12 based on the VMs 11 and 12 being connected to LAN 1.

The tag inference engine 120 can infer a LAN_2_TAG assigned to any VM connected to LAN 2, and a LAN_3_TAG assigned to any VM connected to LAN 3. In the example of FIG. 2, VM 21 is part of a group of VMs connected to both LAN 2 and LAN 3. As a result, both the LAN_2_TAG and the LAN_3_TAG can be assigned by the tag inference engine 120 to VM 21. Database DB1 can be assigned DB_TAG.

A rule 212 (similar to a rule 126 in FIG. 1) can specify that the data service is made up of the frontend VMs 11 and 12, the backend VM 21, and database DB1. Based on the rule 212, the tag rule engine 122 can generate a service tag, TAG_DATA SERVICE, for the data service based on:

$$TAG\_DATA \_SERVICE = LAN\_ 1 \_TAG ‖ LAN\_ 2 \_TAG ‖ LAN\_ 3 \_TAG ‖ DB\_TAG .$$

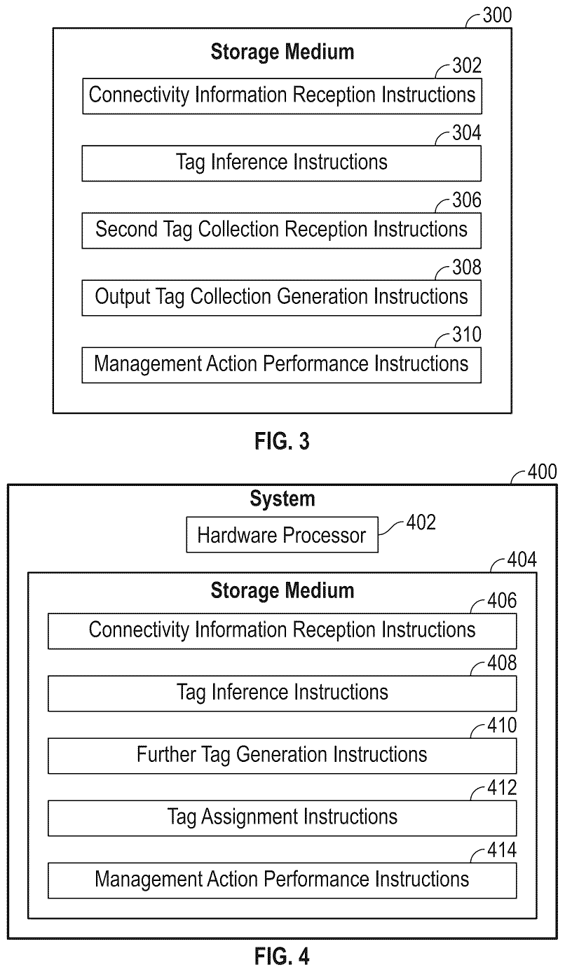

FIG. 3 is a block diagram of a non-transitory machine-readable or computer-readable storage medium 300 storing machine-readable instructions that upon execution caused a system to perform various tasks. The system can include one or more computers.

The machine-readable instructions include connectivity information reception instructions 302 to receive connectivity information indicating how a plurality of resources of a computing environment are connected. The connectivity information may be received from the CEMS 102 of FIG. 1, for example, or derived by agents deployed by the system.

The machine-readable instructions include tag inference instructions 304 to infer, based on the connectivity information, a first collection of tags to associate with the plurality of resources, where the first collection of tags includes a first tag associated with a first group of resources from among the plurality of resources, and a second tag associated with a second group of resources from among the plurality of resources. The tag inference instructions 304 may be part of the tag inference engine 120, for example.

The machine-readable instructions include second tag collection reception instructions 306 to receive a second collection of tags provided from a source. The second collection of tags may be the manual collection of tags 130 or the metadata-based collection of tags 132 of FIG. 1, for example.

The machine-readable instructions include output tag collection generation instructions 308 to generate, based on the first collection of tags and the second collection of tags, an output collection of tags. The output tag collection generation instructions 308 may be part of the tag converter 150 of FIG. 1, for example.

The machine-readable instructions include management action performance instructions 310 to perform a management action in the computing environment using the output collection of tags. The management action performance instructions 310 can be part of a management tool (e.g., 110 or 154 in FIG. 1).

In some examples, the machine-readable instructions can apply a rule (e.g., 126 in FIG. 1) to combine tags from a plurality of collections of tags including the first and second collections of tags to generate a rule-based tag. The generation of the rule-based tag can be performed by the tag rule engine 122 of FIG. 1, for example. The rule-based tag is part of a third collection of tags generated based on respective rules. The output collection of tags is produced further based on the third collection of tags, and the management action is based on the rule-based tag.

In some examples, the machine-readable instructions can receive, from a requester, a request to perform the management action, where the request can include the rule-based tag.

In some examples, the combining of the tags from the plurality of collections of tags includes performing a Boolean operation on tags of the plurality of collections of tags to produce the rule-based tag.

In some examples, the machine-readable instructions can associate the rule-based tag with an entity that uses the first group of resources and the second group of resources. In some examples, the entity can be a service, and the management action relates to the service.

In some examples, the source providing the second collection of tags includes metadata associated with at least some resources of the plurality of resources.

In some examples, the source providing the second collection of tags includes a human interface, such as a user interface or a file provided by a user.

In some examples, the first and second collections of tags are part of a hierarchy of collections of tags from different sources, and the generating of the output collection of tags comprises combining the hierarchy of collections of tags into combined tag information useable by a tool in performing the management action.

FIG. 4 is a block diagram of a system 400, which can be implemented with one or more computers. The system 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The system 400 includes a storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include connectivity information reception instructions 406 to receive connectivity information indicating how a plurality of resources of a computing environment are connected. In some examples, the connectivity information from which the first collection of tags is inferred specifies to which networks respective resources of the plurality of resources are connected. In further examples, the connectivity information from which the first collection of tags is inferred indicates secure network domains in which respective resources of the plurality of resources are included. In additional examples, the connectivity information from which the first collection of tags is inferred includes communication policy used by network devices to determine whether resources are allowed to communicate with one another.

The machine-readable instructions in the storage medium 404 include tag inference instructions 408 to infer, based on the connectivity information, a first collection of tags to associate with the plurality of resources. The first collection of tags includes a first tag associated with a first group of resources from among the plurality of resources, and a second tag associated with a second group of resources from among the plurality of resources.

The machine-readable instructions in the storage medium 404 include further tag generation instructions 410 to generate, using a tag from the first collection of tags, a further tag that is part of a second collection of tags. The further tag can be a rule-based tag generated according to a rule.

The machine-readable instructions in the storage medium 404 include tag assignment instructions 412 to assign the further tag to an entity that uses a set of resources of the plurality of resources. The entity may be a service or another type of entity.

The machine-readable instructions in the storage medium 404 include management action performance instructions 414 to perform a management action in the computing environment with respect to the entity using the further tag.

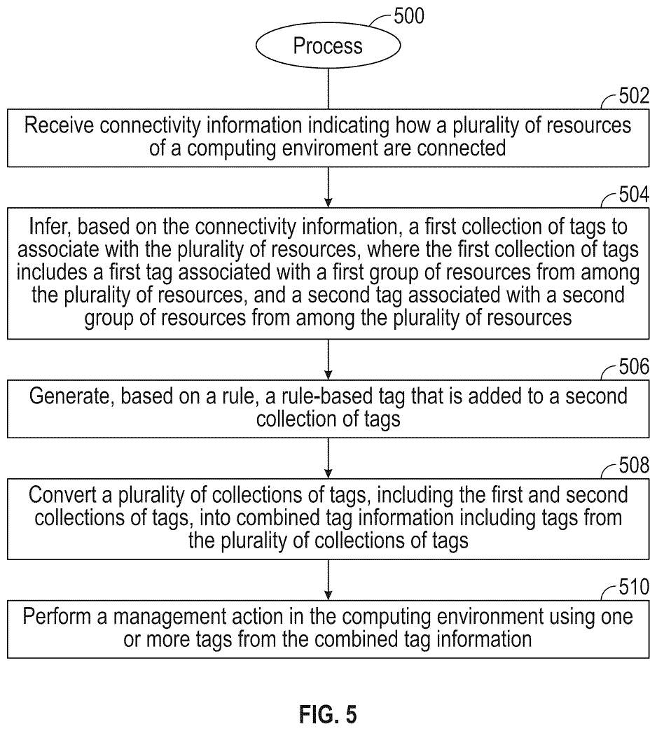

FIG. 5 is a flow diagram of a process 500 according to some examples of the present disclosure. The process 500 includes receiving (at 502) connectivity information indicating how a plurality of resources of a computing environment are connected.

The process 500 includes inferring (at 504), based on the connectivity information, a first collection of tags to associate with the plurality of resources, where the first collection of tags includes a first tag associated with a first group of resources from among the plurality of resources, and a second tag associated with a second group of resources from among the plurality of resources. The inferring can be performed by the tag inference engine 120 of FIG. 1, for example.

The process 500 includes generating (at 506), based on a rule, a rule-based tag that is added to a second collection of tags. The generating of the rule-based tag can be performed by the tag rule engine 122 of FIG. 1, for example.

The process 500 includes converting (at 508) a plurality of collections of tags, including the first and second collections of tags, into combined tag information including tags from the plurality of collections of tags. The plurality of collections of tags can include the hierarchy of tag collections 140, for example. The combining can be performed by the tag converter 150, and the combined tag information includes the output collection of tags 152, for example.

The process 500 includes performing (at 510) a management action in the computing environment using one or more tags from the combined tag information.

As used here, a “processing resource” can include one or more hardware processors. The tag converter 150 and the management tools 110 and 154 of FIG. 1 can be implemented with machine-readable instructions executable by a processing resource.

An “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

FIG. 5 shows a process with an order of tasks. In other examples, the tasks can be performed in a different order, some tasks may be omitted, and other tasks may be added.

A storage medium (e.g., 300 or 404 in FIG. 3 or 4, respectively) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
receive connectivity information indicating how a plurality of resources of a computing environment are connected;
infer, based on the connectivity information, a first collection of tags to associate with the plurality of resources, wherein the first collection of tags comprises a first tag associated with a first group of resources from among the plurality of resources, and a second tag associated with a second group of resources from among the plurality of resources;
receive a second collection of tags provided from a source;
generate, based on the first collection of tags and the second collection of tags, an output collection of tags; and
perform a management action in the computing environment using the output collection of tags.

2. The non-transitory machine-readable storage medium of claim 1, wherein the instructions upon execution cause the system to:
apply a rule to combine tags from a plurality of collections of tags including the first and second collections of tags to generate a rule-based tag,
wherein the rule-based tag is part of a third collection of tags generated based on respective rules,
wherein the output collection of tags is produced further based on the third collection of tags, and
wherein the management action is based on the rule-based tag.

3. The non-transitory machine-readable storage medium of claim 2, wherein the instructions upon execution cause the system to:
receive, from a requester, a request to perform the management action, the request comprising the rule-based tag.

4. The non-transitory machine-readable storage medium of claim 2, wherein the combining of the tags from the plurality of collections of tags comprises performing a Boolean operation on tags of the plurality of collections of tags to produce the rule-based tag.

5. The non-transitory machine-readable storage medium of claim 2, wherein the instructions upon execution cause the system to:
associate the rule-based tag with an entity that uses the first group of resources and the second group of resources.

6. The non-transitory machine-readable storage medium of claim 5, wherein the entity comprises a service, and the management action relates to the service.

7. The non-transitory machine-readable storage medium of claim 2, wherein the source providing the second collection of tags comprises metadata associated with at least some resources of the plurality of resources.

8. The non-transitory machine-readable storage medium of claim 2, wherein the source providing the second collection of tags comprises a human interface.

9. The non-transitory machine-readable storage medium of claim 1, wherein the inferring of the first collection of tags is initiated in response to an event selected from among a user request, a scheduled trigger, or an update of a resource.

10. The non-transitory machine-readable storage medium of claim 1, wherein the inferring of the first collection of tags is performed by a tag management system that is part of a cloud management platform, wherein the computing environment comprises one or more clouds, and the management action is performed by the cloud management platform.

11. The non-transitory machine-readable storage medium of claim 1, wherein the connectivity information from which the first collection of tags is inferred specifies to which networks respective resources of the plurality of resources are connected.

12. The non-transitory machine-readable storage medium of claim 1, wherein the connectivity information from which the first collection of tags is inferred indicates secure network domains in which respective resources of the plurality of resources are included.

13. The non-transitory machine-readable storage medium of claim 1, wherein the connectivity information from which the first collection of tags is inferred includes communication policy used by network devices to determine whether resources are allowed to communicate with one another.

14. The non-transitory machine-readable storage medium of claim 1, wherein the plurality of resources comprise virtual compute entities.

15. The non-transitory machine-readable storage medium of claim 14, wherein the plurality of resources further comprise another resource selected from among a database, a server, a program, or a network device.

16. The non-transitory machine-readable storage medium of claim 1, wherein the first and second collections of tags are part of a hierarchy of collections of tags from different sources, and wherein the generating of the output collection of tags comprises combining the hierarchy of collections of tags into combined tag information useable by a tool in performing the management action.

17. A system comprising:
a hardware processor; and
a non-transitory storage medium storing instructions executable on the hardware processor to:
receive connectivity information indicating how a plurality of resources of a computing environment are connected;
infer, based on the connectivity information, a first collection of tags to associate with the plurality of resources, wherein the first collection of tags comprises a first tag associated with a first group of resources from among the plurality of resources, and a second tag associated with a second group of resources from among the plurality of resources;
generate, using a tag from the first collection of tags, a further tag that is part of a second collection of tags;
assign the further tag to an entity that uses a set of resources of the plurality of resources; and
perform a management action in the computing environment with respect to the entity using the further tag.

18. The system of claim 17, wherein the generating of the further tag is according to a rule specifying a combination of resources used by an entity.

19. A method comprising:
receiving, by a system comprising a hardware processor, connectivity information indicating how a plurality of resources of a computing environment are connected;
inferring, by the system based on the connectivity information, a first collection of tags to associate with the plurality of resources, wherein the first collection of tags comprises a first tag associated with a first group of resources from among the plurality of resources, and a second tag associated with a second group of resources from among the plurality of resources;
generating, by the system based on a rule, a rule-based tag that is added to a second collection of tags;
converting, by the system, a plurality of collections of tags, including the first and second collections of tags, into combined tag information including tags from the plurality of collections of tags; and
performing, by the system, a management action in the computing environment using one or more tags from the combined tag information.

20. The method of claim 19, wherein the second collection of tags includes rule-based tags generated according to respective rules.
